(19) United States
(12) Patent Application Publication
(10) Pub. No.: US 2008/0313215 A1
(43) Pub. Date: Dec. 18, 2008

(54) SYSTEM AND METHOD FOR THE GENERATION AND STORAGE OF CONTEXTUALLY ANCHORED LINKS AND FOR NAVIGATION WITHIN INFORMATION SYSTEMS BASED ON SUCH LINKS

(75) Inventors: Tuvik Beker, Iowa City, CA (US); Yoav Hadani, Maple (CA); Amir Beker, Rosh-Haayin (IL)

Correspondence Address: DLA PIPER US LLP, 2000 UNIVERSITY AVENUE, E. PALO ALTO, CA, 94303-2248, US

(73) Assignee: R-Web, Inc., Iowa City, IA (US)

(21) Appl. No.: 12/139,325

(22) Filed: Jun. 13, 2008

Related U.S. Application Data
(60) Provisional application No. 60/934,532, filed on Jun. 13, 2007.

(51) Int. Cl. G06F 17/30

(52) U.S. Cl. 707/102; 707/E17.009

(57) ABSTRACT

A system and method for information management through the use of relational links are provided.

### PRIORITY CLAIM

This application claims the benefit under 35 USC §§ 119(e) and 120 from U.S. Provisional Patent Application Ser. No. 60/934,532, filed on Jun. 13, 2007, and entitled “System and Method for the Generation and Storage of Content-Rich Links and for Navigation Within Information Systems Based on Such Links” and is incorporated herein by reference in its entirety.

### FIELD

A system and method for generating and storing contextually anchored links is disclosed.

### BACKGROUND

Hyperlinking between different information elements is the core of many modem information systems. In particular, this is the hallmark of the World Wide Web. Despite the many advances the Web has gone through, the concept and methodology of hyperlinking has remained virtually unchanged since the first days of the Web. Standard hyperlinks are one-directional, mostly hard-coded into the web content, and convey no information about the type of relation between the linked page and the linking one.

Changing the way in which information elements are hyperlinked could lead to several improvements in information retrieval and use: (1) Improved navigation, through better mapping of semantic relationships between content elements; (2) Flexible information structures, shaped into different ‘perspectives’ according to user preferences; (3) Better ranking and search algorithms, based not only on the number of links between different pages, but also on the types of such links; (4) Better focusing and matching of online advertising content to user interests and profiles.

Such improvements can be realized by replacing the traditional hyperlinks with ‘relational links’—smart links which contain information about the relation between the elements at the two ends of the link. Such relational links can connect two information nodes, and they can also connect a single information node to a “context” of multiple other information nodes.

Therefore, there exists a need for a system that will provide relational links between information nodes, and between information nodes and contexts in an information system, and will take advantage of these relational links to provide improved navigation, dynamic information structures, better capabilities for ranking and search of information, and better advertising matching.

### BRIEF DESCRIPTION OF THE DRAWINGS

FIG. 1 illustrates a relational information management system;

FIG. 2 illustrates an example of the user data in the system in FIG. 1;

FIG. 3 illustrates an embodiment of the relational storage module of the system in FIG. 1;

FIG. 4 illustrates another embodiment of the relational storage module of the system in FIG. 1;

FIG. 5 illustrates a method for the generation of a list of relational links from information stored in the information storage module shown in FIG. 4;

FIG. 6 illustrates another embodiment of the relational information management system;

FIG. 7 illustrates a relational website generation and editing system;

FIG. 8 illustrates a method for converting a relational website into a standard website;

FIG. 9 illustrates another embodiment of the relational website generation and editing system;

FIG. 10 illustrates a method for analysis of an existing website and generation of a new relational website;

FIG. 11 illustrates a system for navigating content stored in a centralized or distributed information system;

FIG. 12 illustrates more details of the content mapping modules of the system in FIG. 11;

FIG. 13 illustrates more details of the information system of the system in FIG. 11;

FIG. 14 illustrates more details of another information system of the system in FIG. 11;

FIG. 15 illustrates a screenshot of a window of a browser used with the system in FIG. 11;

FIG. 16 illustrates another screenshot of a window of a browser used with the system in FIG. 11;

FIG. 17 illustrates yet another screenshot of a window of a browser used with the system in FIG. 11; and

FIG. 18 illustrates yet another screenshot of a window of a browser used with the system in FIG. 11.

FIG. 19 illustrates a block diagram of a system for generating relational links between pages on the web.

FIG. 20 illustrates a flow chart of a process for defining a subject context, as part of the system of FIG. 19.

FIG. 21 illustrates a flow chart of a process for bookmarking a page within a given context, as part of the system of FIG. 19.

FIG. 22 illustrates a flow chart of a process for cross-bookmark analysis of contextual bookmarks, as part of the system of FIG. 19.

FIG. 23 illustrates a flow chart of a process for domain sampling, as part of the system of FIG. 19.

FIG. 24 illustrates a flow chart of a process for domain analysis, as part of the system of FIG. 19.

FIG. 25 illustrates illustrated a flow chart of a process for domain extension, as part of the system of FIG. 19.

FIG. 26 illustrates another possible embodiment of the relational storage module of the system in FIG. 1.

FIG. 27 illustrates a possible process for generation of a list of relational links from information stored in the relational storage module presented in FIG. 26.

FIG. 28 illustrates a screenshot of a browser with a relational-navigation plug-in developed by R-Web Inc., which embodies several of the systems and methods of the present invention.

FIG. 29 illustrates another screenshot of a browser with the relational-navigation plug-in of FIG. 28.

### DETAILED DESCRIPTION OF ONE OR MORE EMBODIMENTS

To meet the needs described above, a system and method for information management through the use of relational links is provided, which includes: a means for storing information about relations between nodes corresponding to different content elements, and between information nodes and more general “contexts”—knowledge domains characterized by sets of information nodes pertaining to them; a means for accessing, given a particular node, all the other nodes having stored relations with that given node, as well as all the other nodes having stored relations with a context pertaining to that given node; and a means for presenting, given a list of inter-related nodes, this list of nodes and the relations between them. Also, a system and method is provided for creating websites wherein links between different content elements of the site are based on the relations between these content elements. In addition, a system and method for navigating content stored in a centralized or distributed information system is provided which includes: a means for displaying content stored in the information system; a means of accessing a specific content element by specifying a Uniform Resource Identifier (URI) corresponding to that element; a content mapping module for generating, storing, and accessing links between content elements based on relationships between such elements; and a navigation module for displaying links to one or more content elements, wherein the links are obtained from the content mapping module based on their relations to the content currently being displayed in the display module, and other attributes provided by the navigation module. Finally, a system and method is also provided for generating relational links between pages and contexts on the web, which includes: a means for human users to easily specify relational links between web pages and between pages and contexts, and/or a means for automatically or semi-automatically analyzing information, finding relations between different web pages, and creating contexts and relational links corresponding to these relations.

The system concerns ways in which documents and other information resources relate to each other, and how putting information into context can allow for better navigation within large information systems. In the system, an information resource/node may be any document, media clip, web page, or other type of data entity which contains information.

An information context may be a set of information resources which share some common property—primarily a common subject. An information context can be referred to either by the property shared by all the constituent information resources, or by enumeration of its elements. To give a simple numerical analogy, the set {2,4,6,8} can be referred to either through this enumeration of its members, or through the property of “positive even numbers smaller than 10”. A context may be implicit if the property common to its members is unknown and explicit if this property is known.

The system and method may include two types of relations—relations between two information resources, and relations between an information resource and a context. Intuitively, saying the information resource B relates to information resource A through relation R should indicate what is the common basis for A and B, and what information B adds to what is contained in A. Saying that information resource A is in relation R to context C places it in a subset of the resources comprising context C (together with all the other resources which are in relation R to C). A relation between a resource and a context induces relations between this resource and other resources in the same context. As an example, assume that the context C can be characterized as “information about camels”, that A is a page discussing the economic value of camels, and B is a page about captive husbandry of camels. A can be said to be in the relation “Economic significance” with the context and with B. Note that a single information resource can participate in multiple contexts and in multiple relations within each context.

The system and method are now described with reference to the drawings, wherein like reference numerals are used to refer to like elements throughout. In the following description, for purposes of explanation, specific details are set forth in order to provide a thorough understanding of the system and method. It is evident, however, that the system and method may be practiced without these specific details. In other instances, well-known structures and devices are shown in block diagram form in order to facilitate describing the system and method.

As used in this application, the terms “module” and “system” are intended to refer to a computer-related entity, either hardware, a combination of hardware and software, software, or software in execution. For example, a module may be, but is not limited to being, a process running on a processor, a processor, an object, an executable, a thread of execution, a program, and/or a computer. By way of illustration, both an application running on a server and the server can be referred to as modules. One or more modules may reside within a process and/or thread of execution and a module may be localized on one computer and/or distributed between two or more computers.

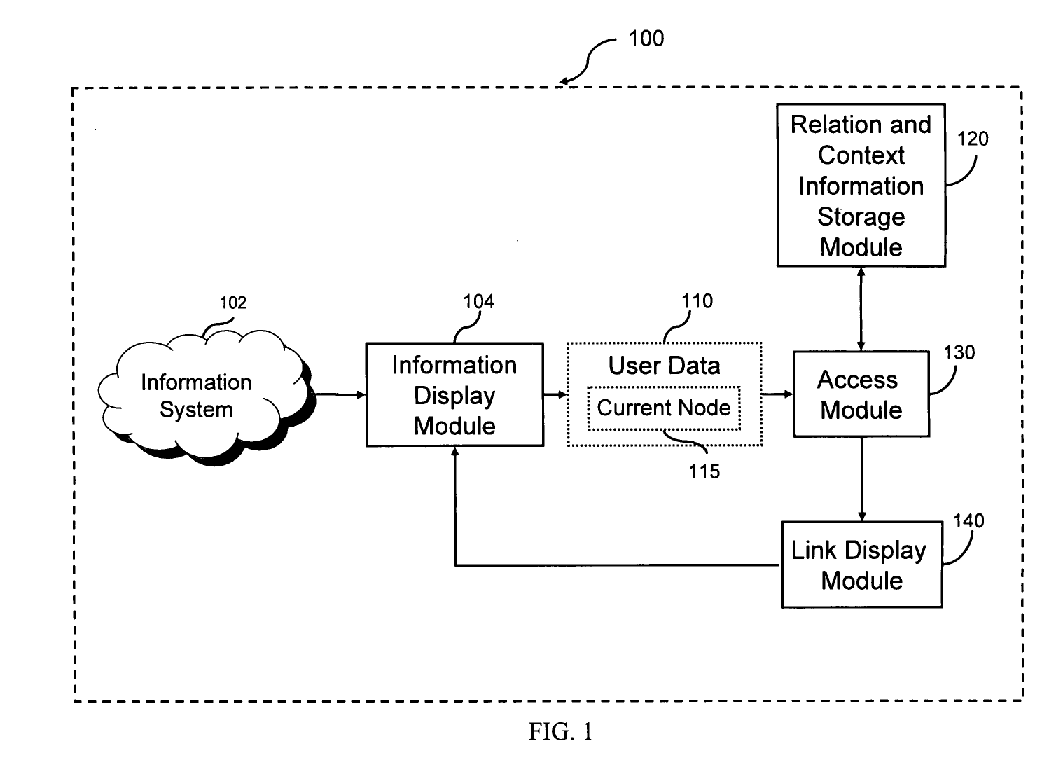

Referring now to FIG. 1, there is illustrated a block diagram of a relational information management system 100 that facilitates information management. The information management tool includes a novel architecture where information about relationships between content elements in an information system 102 can be accessed independently of access to the content elements themselves. The information system 102 may be implemented on a single computer, or on a networked system of computers distributed throughout one building, several buildings, or multiple locations all over the world. The information system may include many different software components, handle multiple types of digital information media, and support multiple access modes and protocols.

In support thereof, the system 100 contains, in addition to the information system 102, which can be either localized or distributed, an information display module 104, a relation and context information storage module 120, a relation information access module 130, and a link display module 140.

When a user uses the information display module 104 to view information stored in the information system 102, certain user data 110 is passed to the relation information access module 130. This user data would usually include at least information about the currently viewed information node 115 (also referred to hereafter from time to time as the “pivot node”), and may also include additional data as will be detailed below. The relation information access module 130 retrieves information about relations between different content elements in the information system 102 from the information storage module 120. The choice of which relation information to retrieve is guided by the user data 110. The access module 130 then filters the retrieved relation information and sends a subset thereof to the link display module 140. The link display module then formats the retrieved relation information into a set of links to content elements within the information system 102 and displays these links. The display of the links can be in any number of ways, including, but not limited to, as a list of information nodes ordered by the type of relation they have to the currently viewed node, or as a connected graph where the nodes represent content elements and the arcs represent different types of relations between the nodes. The type of relation between two nodes can also be displayed in any number of ways, including, but not limited to, using text to describe the relation type, or using different graphical characteristics (color, font, line type or width) to represent different types of links. If the user chooses a node from the link display module 140, this node will be displayed in the information display module 104.

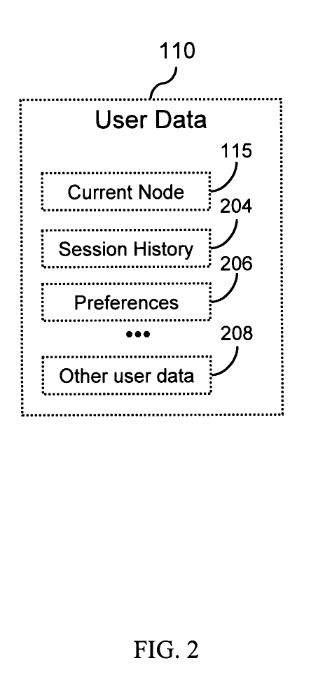

Referring now to FIG. 2, there is illustrated a diagram of possible elements of user data 110 sent to the access module 130. Such user data can consist of any number of elements, including, but not limited to, which is the currently viewed information node 115, session history 204 detailing which nodes have been viewed before by the user during the same session, any set of user preferences 206 guiding the access module 130 in the process of retrieving and filtering relation information, and any number of additional user data elements 208.

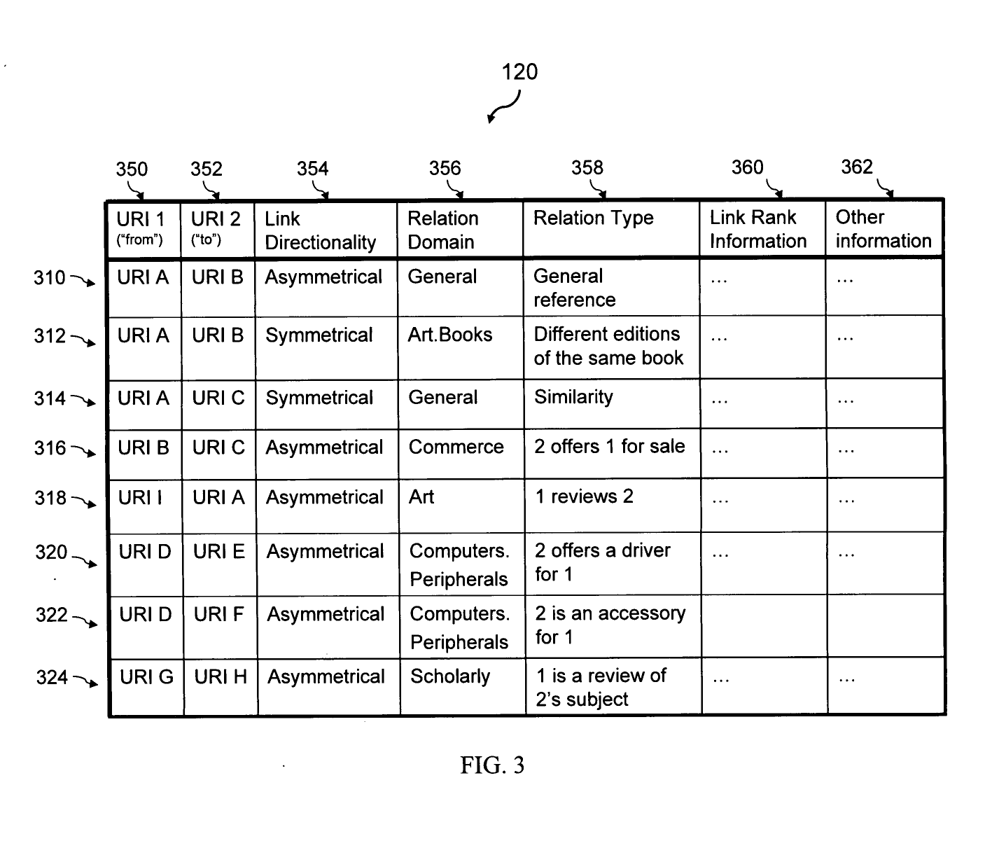

Referring now to FIG. 3, there is illustrated one possible embodiment of the information storage module 120 in the form of a table in a Relational Database. In this embodiment, each record in the database table holds information about a single relational link. In the specific example presented, 8 relational links—numbered 310, 312, . . . 324—are stored in the database table.

In the specific example presented here, each record has 7 fields numbered 350, 352, . . . 362. Field 350 indicated the information node at one end of the relational link (URI A for example in record 310), and field 352 that indicates the information node at the other end of the relational link (URI B for example in record 310). Field 354 indicates whether the relation between the two linked nodes is symmetrical (the link is bidirectional) or asymmetrical (the link is unidirectional). Field 356 specifies a domain in which the relation between the two linked nodes is defined. Field 358 specifies the type of relation between the two linked nodes, subject to the relation domain specification given in field 356. Field 360 holds some information about the rank of the link, which may, for example, be used by algorithms that search and rank link and nodes for various purposes and according to various parameters. Field 362 holds some additional information about the link referenced in the record.

For the sake of illustrating the idea, in the specific example presented here, records 310 and 312 both refer to links between the same two nodes—referenced by URI A and URI B, respectively. However, the two relational links are different: record 310 holds an asymmetrical link of a ‘general’ type, similar to a standard, non-type-specific HTML markup hyperlink. Record 312, on the other hand, holds more specific relational link type information. It specifies that there exists a symmetrical relation between the two information nodes referenced by URI A and URI B, whereby the two nodes contain information about two different editions of the same book.

It is to be understood and appreciated that the system and method are not limited by the details of the specific example shown herein. The methods may be practiced with other definitions for the structure of a record describing a relational link, including, but not limited to, a different number of fields per record, and a different set of fields, provided that each record uniquely identifies the two nodes connected by the relational link it references. Those skilled in the art will further understand and appreciate that the content of a field in an embodiment of the information storage module 120 in the form of a table in a Relational Database may be a complex data structure, including, but not limited to, an XML document or a script which, when executed, produces some information which should be substituted for the value of that field.

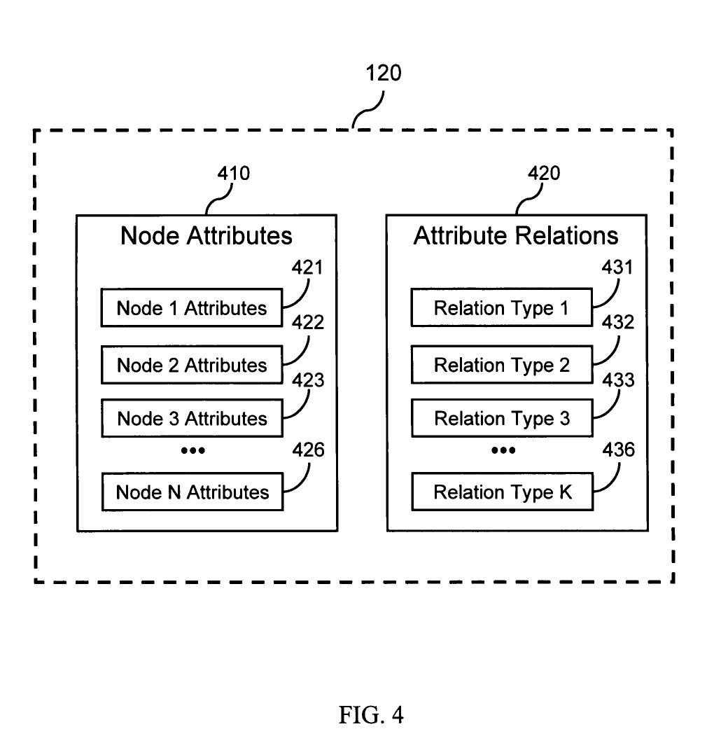

Referring now to FIG. 4, there is illustrated another possible embodiment of the information storage module 120. In this embodiment the information storage module incorporates a module for storing node attributes 410, and a means for storing information about relations between various attributes 420. In this embodiment, a list of relational links is not stored explicitly in the information storage module 120. However, such a list can be readily computed by the access module 130 from information stored in the information storage module 120, as described below.

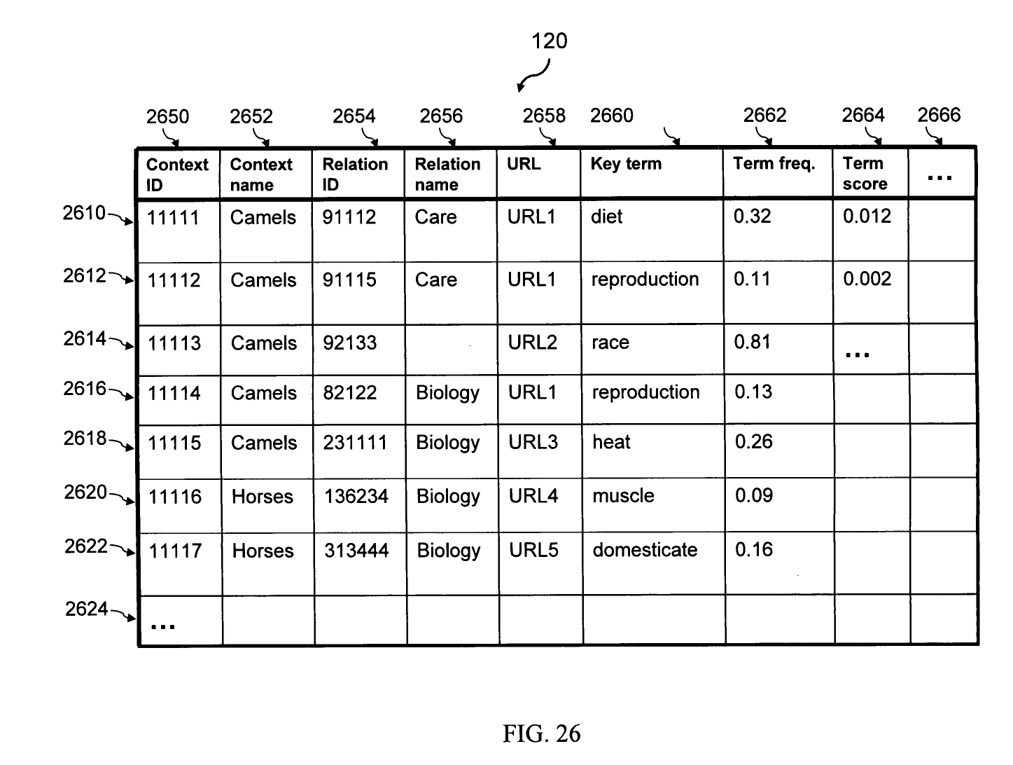

Referring now to FIG. 26, there is illustrated another possible embodiment of the information storage module 120. In this embodiment the module stores information about contexts and relations in a textual table: each row in the table provides statistical information (stored in fields 2662, 2664, and onward) about a single key term (stored in field 2660), found in a particular URL (field 2658), which is in relation of certain ID (field 2654) and possibly name (field 2656) to the context of that row, having a certain id (field 2650) and possibly name (field 2652). It is to be understood and appreciated that the system and method are not limited by the details of the specific example shown herein. In particular, those skilled in the art will understand and appreciate that other data structures may be more suitable—in terms of storage space, access time, or both—for storing the same information. The methods of this invention may be practiced with such other data structures as long as they convey the essential information about contexts, relations, URLs, and terms. It should be further understood and appreciated that the storage module 120 may combine multiple types of information and multiple ways of storing such information. For example, it may store information about relations between pairs of URLs in accordance with the embodiment presented in FIG. 3, as well as information about contexts and relations of URLs to context in accordance with the embodiment presented in FIG. 26.

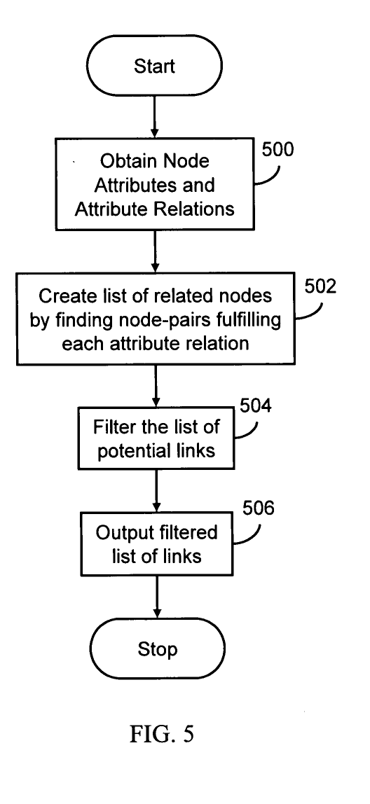

Referring now to FIG. 5, there is illustrated a flow chart of a process for generation of a list of relational links from information stored in the information storage module 120 as presented in FIG. 4, in accordance with the present invention. While, for purposes of simplicity of explanation, the one or more methodologies shown herein, e.g., in the form of a flow chart, are shown and described as a series of acts, it is to be understood and appreciated that the present invention is not limited by the order of acts, as some acts may, in accordance with the present invention, occur in a different order and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the present invention.

At 500, node attributes and attribute relations are obtained from the information storage module 120. At 502, a list of potential relational links is created by finding node pairs whose attribute sets fulfill one or more attribute relations. At 504, the list of potential relational links is filtered. Filtering can be based on any number of criteria, including, but not limited to, having a pivot node at one end of the link, fulfilling a given set of attribute matching conditions, fulfilling a minimum number of attribute matching conditions, or obtaining a minimum link rank, where each fulfilled attribute matching rule contributes a certain rank to the link. At 506, the access module 130 outputs the resulting list of relational links that passed the filtration process.

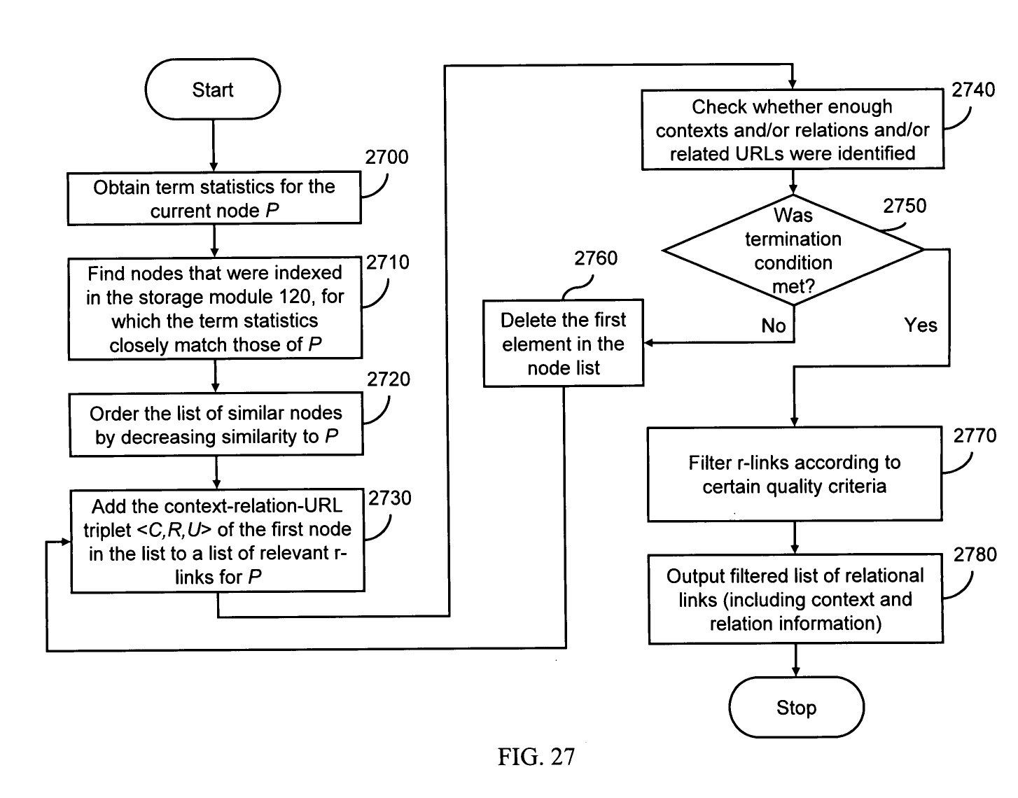

Referring now to FIG. 27, there is illustrated another possible process for generation of a list of relational links in accordance with the present invention, this time from information stored in the information storage module 120 as presented in FIG. 26. At 2700, term statistics are obtained for the currently accessed node P. At 2710 a list of nodes is created, containing nodes indexed in the storage module 120, for which the term statistics closely resemble those of node P. At 2720 this list of nodes is ordered by decreasing order of term statistics similarity to P. At 2730, a relational link to the first node in the list (formally, a context-relation-URL triplet <C,R,U>) is added to a list of candidate r-links for P. At 2740, it is checked whether enough r-links have been obtained for P (which may depend, for example, on the total number of URLs and/or different relations and/or different contexts identified for P). If not, the first node in the ordered list of similar nodes is deleted and the process returns to stage 2730. Once the termination condition has been met, at 2770, the list of candidate r-links is filtered according to certain quality criteria. At 2780, the filtered list of r-links is being output.

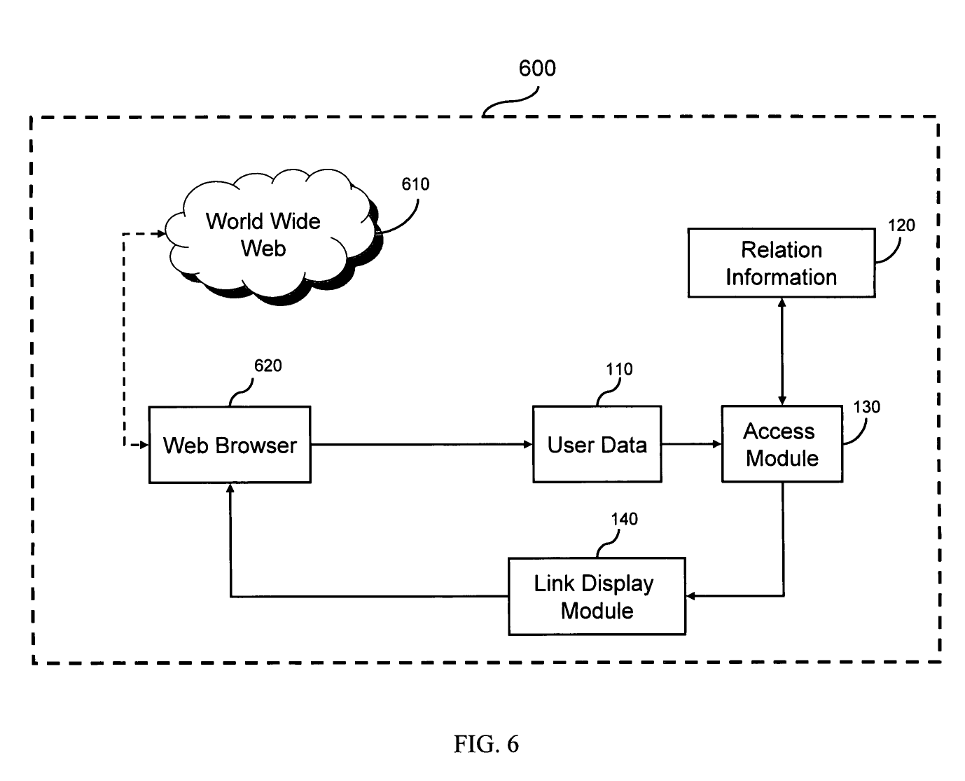

Referring now to FIG. 6, there is illustrated a block diagram of an embodiment 600 of the relational information management system 100, wherein the information system 102 is the World Wide Web 610, and the information display module 104 is a standard web browser 620. Those skilled in the art will appreciate that that the inventive methods may be practiced with various computer system configurations, including single-processor or multiprocessor computer systems, minicomputers, mainframe computers, as well as personal computers, hand-held computing devices, cellular phones, microprocessor-based or programmable consumer electronics, and the like, each of which may be operatively coupled to one or more associated devices. The illustrated aspects of the system may also be practiced in distributed computing environments where certain tasks are performed by remote processing devices that are linked through a communications network. In a distributed computing environment, program modules may be located in both local and remote memory storage devices.

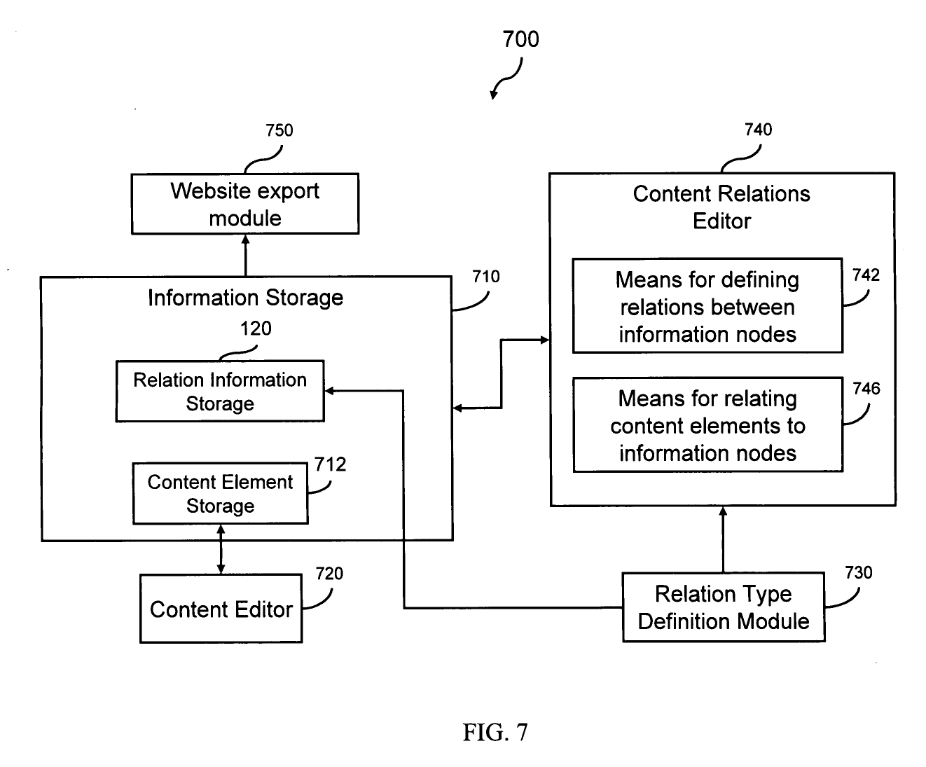

Referring now to FIG. 7, there is illustrated a block diagram of a relational website generation and editing system 700, wherein links between different content elements of the site are based on relations between these content elements. This system 700 comprises an information storage module 710, a content editor 720, a relation type definition module 730, a content relations editor 740, and a website export module 750. The content editor 720 allows the user of the system to create, edit or modify web pages containing various content elements. Such content elements can be of any number of types, including, but not limited to, text, multimedia, executable programs, and other binary data attachments. The content editor 720 allows the user of the system to create, edit or modify web-page style-sheets. The specifications within such a style sheet can determine, among other things, the location, graphical characteristics, and display format for relational links of any specific type that pertain to a particular web page. The relation definition module 730 allows the user to define, create, edit and modify different types of relations between information nodes in accordance with that invention. The content relations editor 740 comprises a means for defining relations between information nodes 742, and a means for relating content elements to information nodes 746. The information storage module 710 comprises a content element storage module 712 and a relation information storage module 120 in accordance with the current invention. The content element storage module 712 enables content elements, web-pages, and web-page style-sheets created or modified by the content editor 720 to be stored. The relation information storage module 120 allows relation types created or modified by the relation definition module 730, and relational links generated by the content relations editor 740 to be stored and retrieved. The website export module 750 enables the user to export the created website for viewing on the World Wide Web or on a local area network. The same relational website can be exported in a variety of forms, including, but not limited to, a form suitable for viewing by a relational information management system 100, or a form suitable for viewing by a conventional web browser 620. To export a relational website in a form suitable for viewing by a relational information management system 600, the web-pages created by the content editor 720 and stored in the content element storage 712 are made accessible to a web browser 620, whereas the relation information stored in the relation information storage 120 is made accessible, through an appropriate communication protocol, to the access module 130 of the system 600. To export a relational website in a form suitable for viewing by a conventional web browser 620, the website export module 750 converts the relational links stored in the relation information storage 120 into conventional hyperlinks, and embeds these hyperlinks into the web pages stored in the content element storage 712, to create a conventionally-linked version of the website. This conventionally-linked version of the website is then made accessible to a web browser 620.

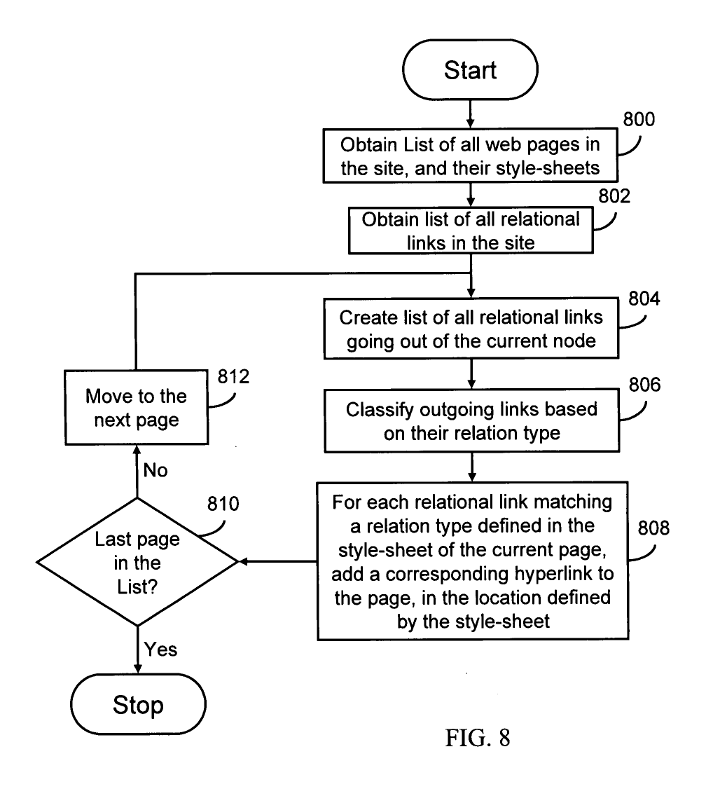

Referring now to FIG. 8, there is illustrated a flow chart of a process for converting a relational website into a standard website viewable with a conventional web browser 620. Such a process can be used by the website export module 750 of the present invention. At 800, a list of all the web-pages in the relational site, and their corresponding style-sheets, is obtained from the content element storage 712. At 802, a list of all the relational links in the relational site is obtained from the relation information storage 120. At 804, the list of all relational links going out of the current node is created. At 806, the relational links in that list are classified according to their link type. At 808, the style-sheet for the current page is examined. For each relation type specified in the style-sheets, all the relational links having that type and going out of the current page are identified. These links are then embedded in the page as conventional hyperlinks, according to the specifications of the style-sheet with respect to location, graphical properties, and more. At 810, it is checked whether the list of pages in the relational site has been thus exhausted. If so, the process ends. If not, the next page is retrieved, and the process returns to stage 804.

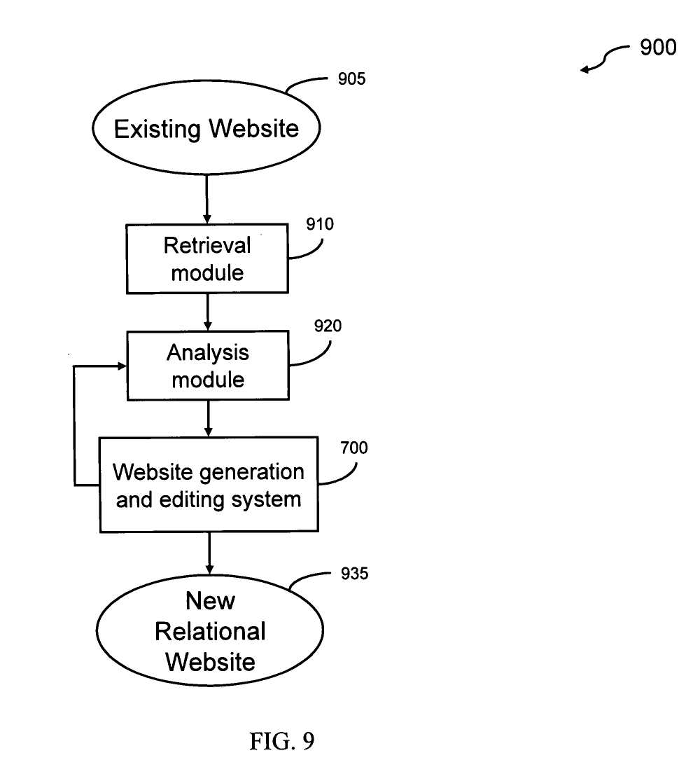

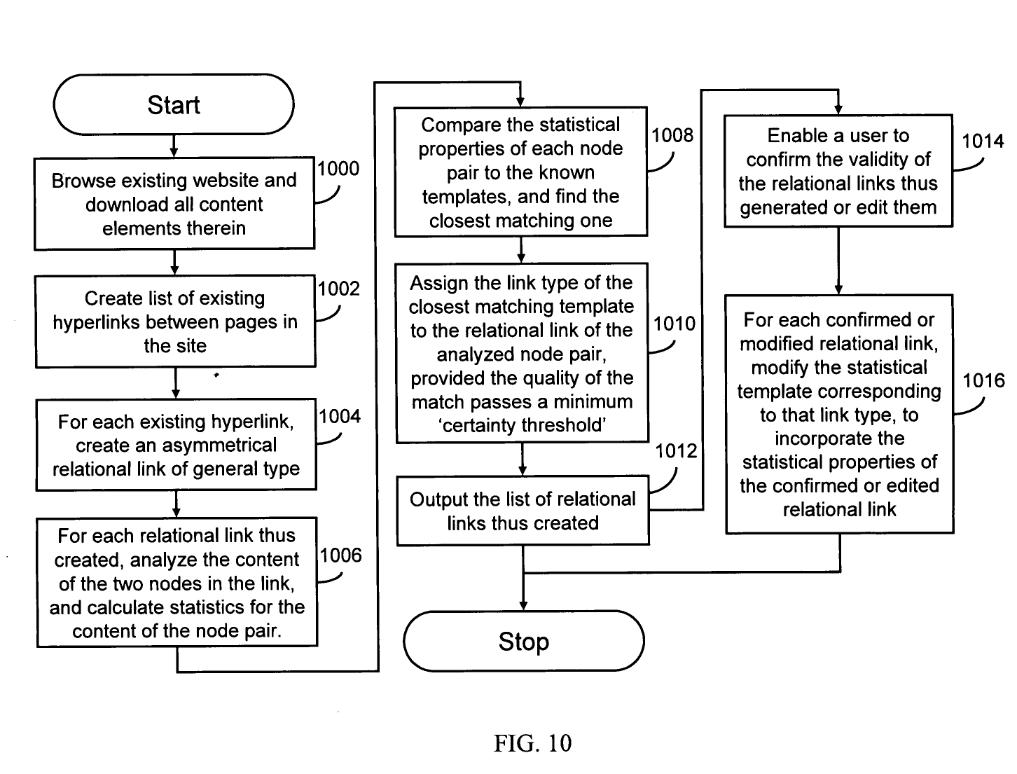

Referring now to FIG. 9, there is illustrated a block diagram of a relational website generation and editing system 900. The system 900 resembles the system 700, but has an additional retrieval module 910 and analysis module 920 for retrieving and analyzing an existing website 905, and generating a new relational website from it. The next figure outlines a process for doing so. The retrieval module 910 collects all the content and structure information from the existing website 905. The analysis module 920 analyses that information, and based on it creates potential relational links between pages in the website. The relational website generation and editing system 900 allows the user to refine the relational website structure, by either confirming the potential relational links suggested by the analysis module 920, or modifying or overriding them. Such refinement leads in turn to improvement of the analysis module 920. The process is illustrated in more detail in FIG. 10. Once the user is satisfied with the resulting relational website, it can be exported to create a new relational website 935.

Referring now to FIG. 10, there is illustrated a flow chart of a process for the analysis of an existing website and the generation of a new relational website. At 1000, the existing website is browsed, and a list of all content elements therein is created. At 1002, a list of all hyperlinks between web pages in the site is created. At 1004, an asymmetrical relational link of type ‘general’ is created for each hyperlink in the original site, having the page in which the original hyperlink was found as URI 1, and the page it linked to as URI 2. At 1006, for each hyperlink created in that way, a statistical analysis of the content of the two nodes in the link is performed. At 1008, the statistical properties of the pair of nodes are compared with a set of ‘template statistics’, each corresponding to a family of relational links sharing the same type. The closest matching template is identified, and a similarity rank is calculated based on the similarity of the current node-pair statistics to that of the closest matching template. At 1010, the link type of the best-matching template is assigned to the relational link, provided the similarity rank passes a certain similarity threshold. At 1012, the list of all relational links thus created is passed on to the relational website generation and editing system 700, where the user can either confirm the validity of the relational links or modify them. At 1016, for each relational link modified or confirmed, the statistics of the node pair pertaining to that link are added to the template for that link type.

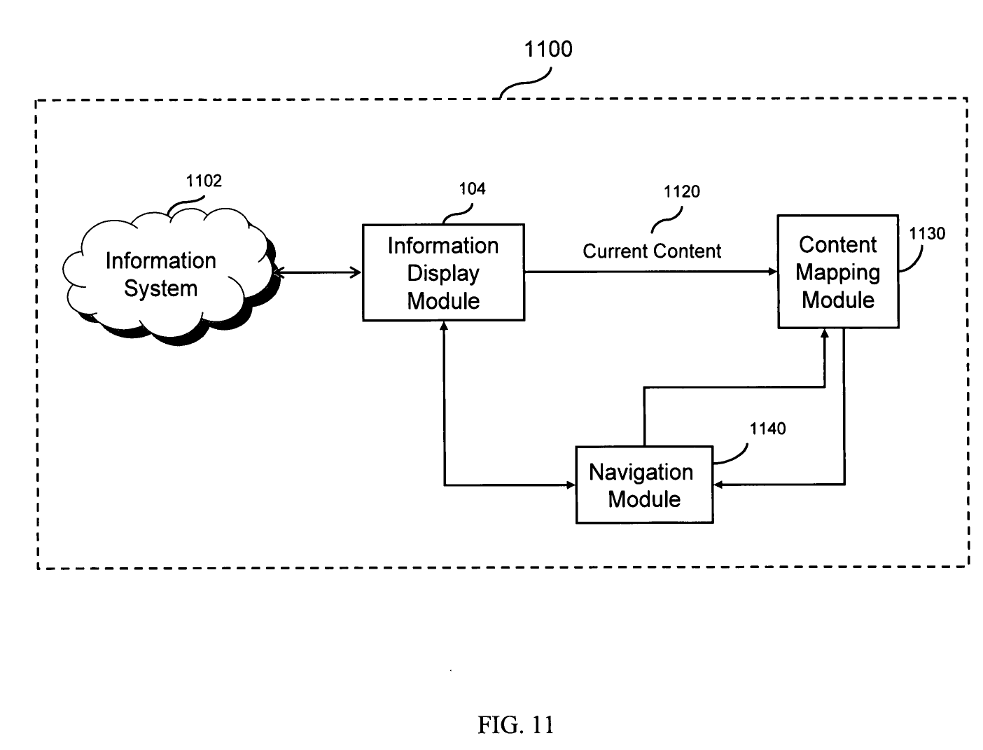

Referring now to FIG. 11, there is illustrated a block diagram of a system 1100 for navigating content stored in a centralized or distributed information system 1102. This system 1100 comprises a display module 1102; a content mapping module 1130 for mapping relations between the currently viewed information and other related information in the information system 1102; and a navigation module 1140 for displaying the content maps generated by the content mapping module 1130. The navigation module may present content maps in any number of ways, including, but not limited to, as a list of information nodes ordered by the type of relation they have to the currently viewed node, or as a connected graph where the nodes represent content elements and the arcs represent different types of relations between the nodes. The type of relation between two nodes can also be displayed in any number of ways, including, but not limited to, using text to describe the relation type, or using different graphical characteristics (color, font, line type or width) to represent different types of links. If the user chooses a node from the link navigation module 1140, this node will be displayed in the information display module 104.

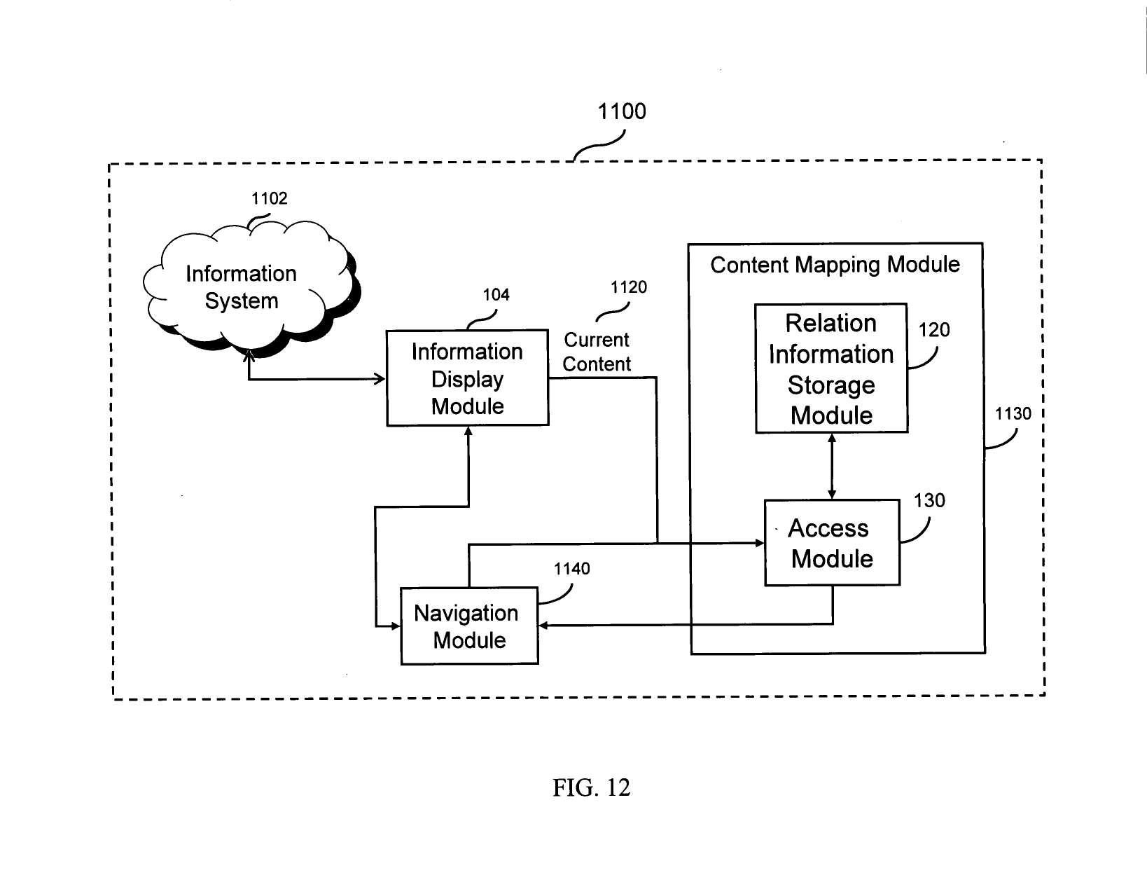

Referring now to FIG. 12, there is illustrated a block diagram of the system 1100, wherein the content mapping modules is comprised of a relation information storage module 120, and an access module.

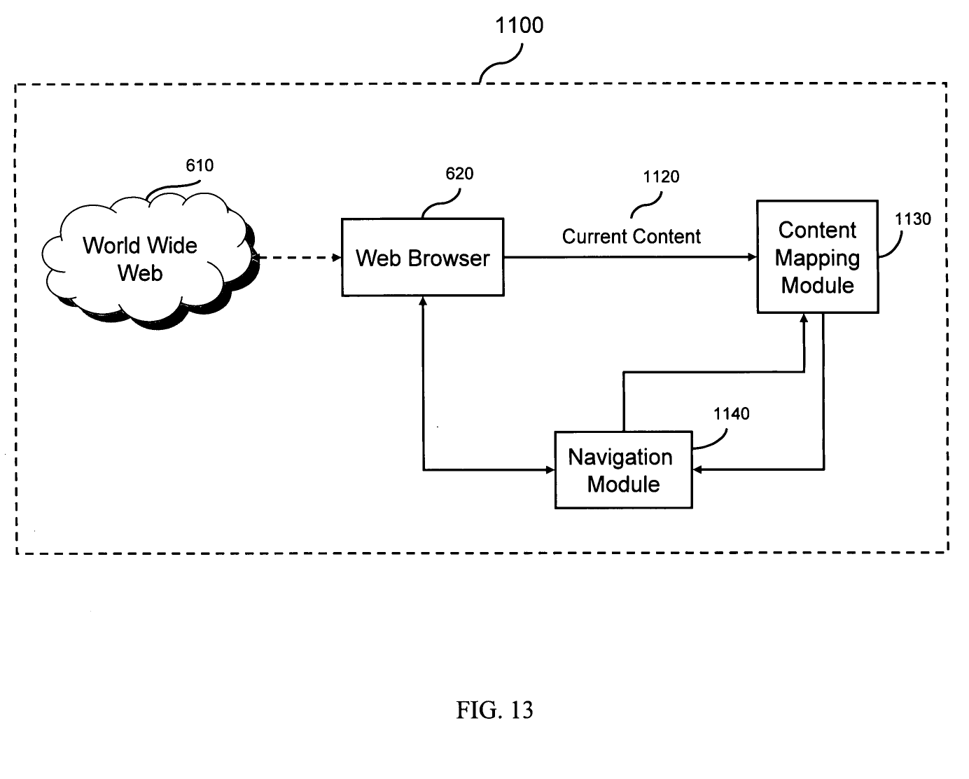

Referring now to FIG. 13, there is illustrated a block diagram of the system 1100, wherein the information system 102 is the World Wide Web 610, and the information display module 104 is a web browser 620. Those skilled in the art will understand and appreciate that the embodiment of the navigation module 1140 in this implementation can take multiple forms, including, but not limited to, a browser plug-in, an embedded code scriptlet, or a frame-based portal with one frame displaying chosen URLs and another frame displaying content maps relevant to these URLs. In each of these alternative implementations, the navigation module communicates with the content mapping module 1130 which typically resides on another server, obtaining from it content maps and displaying them within the web browser.

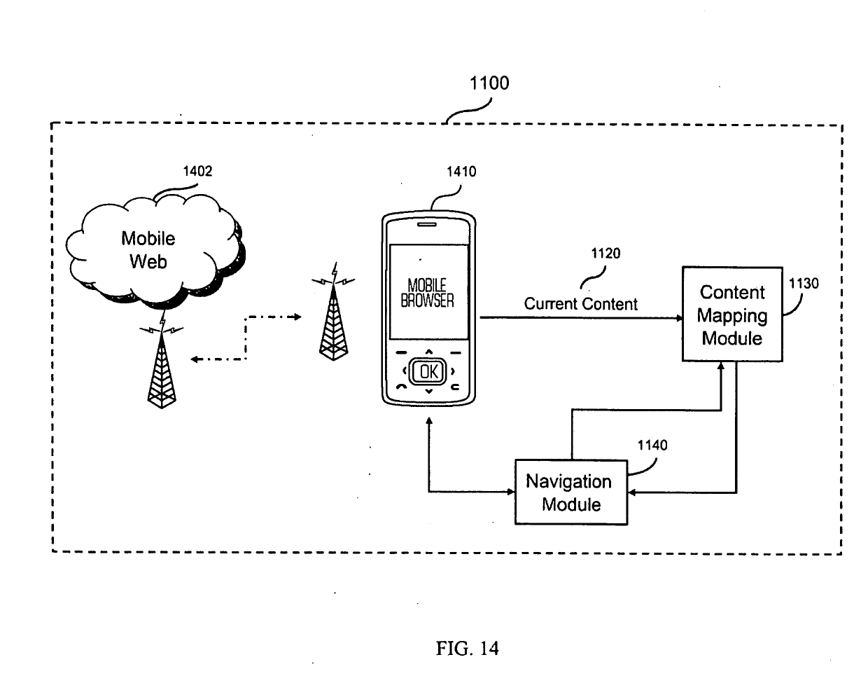

Referring now to FIG. 14, there is illustrated a block diagram of the system 1100, wherein the information system 102 is the Mobile Web 1402, and the information display module 104 is a mobile device such as smart phone or PDA equipped with a mobile web browser 1410.

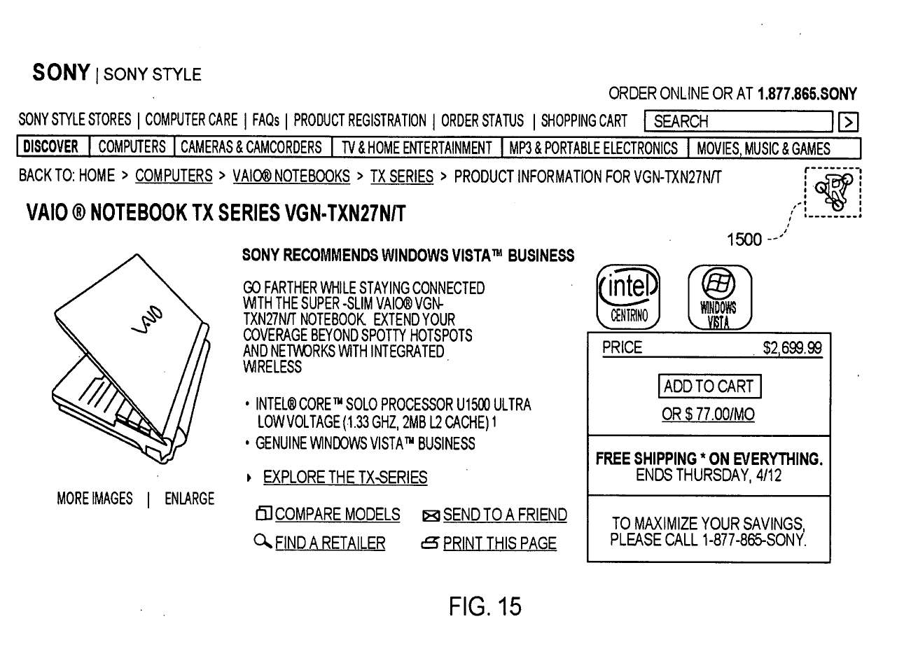

Referring now to FIG. 15, there is illustrated a screenshot of a window of a browser used in conjunction with the system 1100. The current content displayed in the web browser is of a web page displaying a certain notebook computer. On top of the displayed page, an icon 1500 is displayed. This icon 1500 is not part of the content of the displayed page. It is part of the navigation system 1100, and clicking on it with the mouse opens a pop-up navigation window, as shown in the next figure.

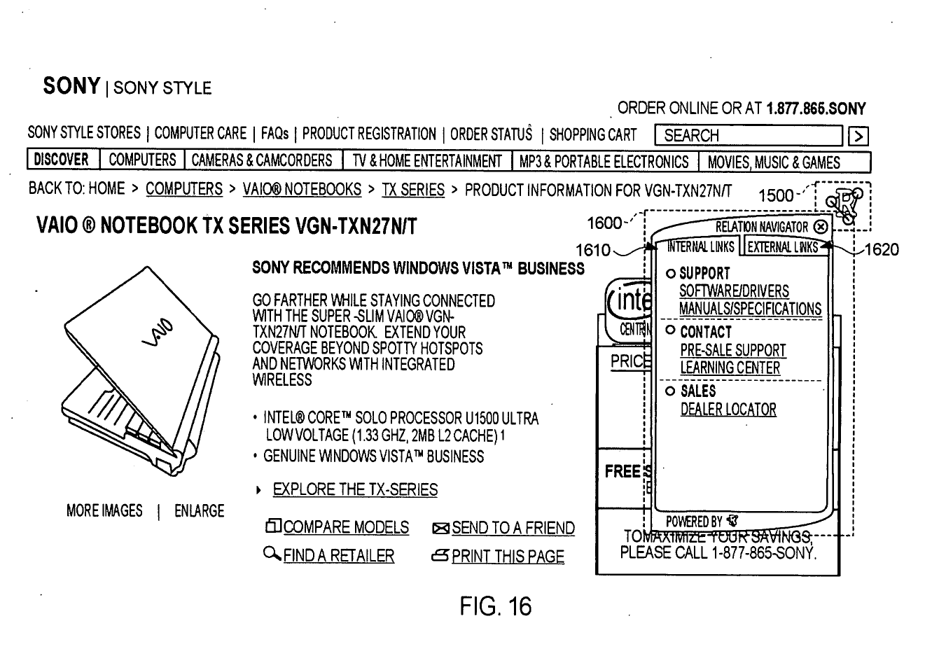

Referring now to FIG. 16, there is illustrated a screenshot of the same web page as in the FIG. 15. This time, the user has clicked on the icon 1500, and a relation navigation window 1600 has popped up on top of the displayed web page. The navigation window 1600 has two panels. Panel 1610, currently selected, presents internal relational links, that is, relational links which lead to pages within the same domain as the current page. In the example shown, there are several such relational links, grouped into three link categories—“support, “Contact”, and “Sales”. The user can choose between the two panels by clicking on the top part of each. Clicking on a relational link within the relation navigator opens that link in the browser window.

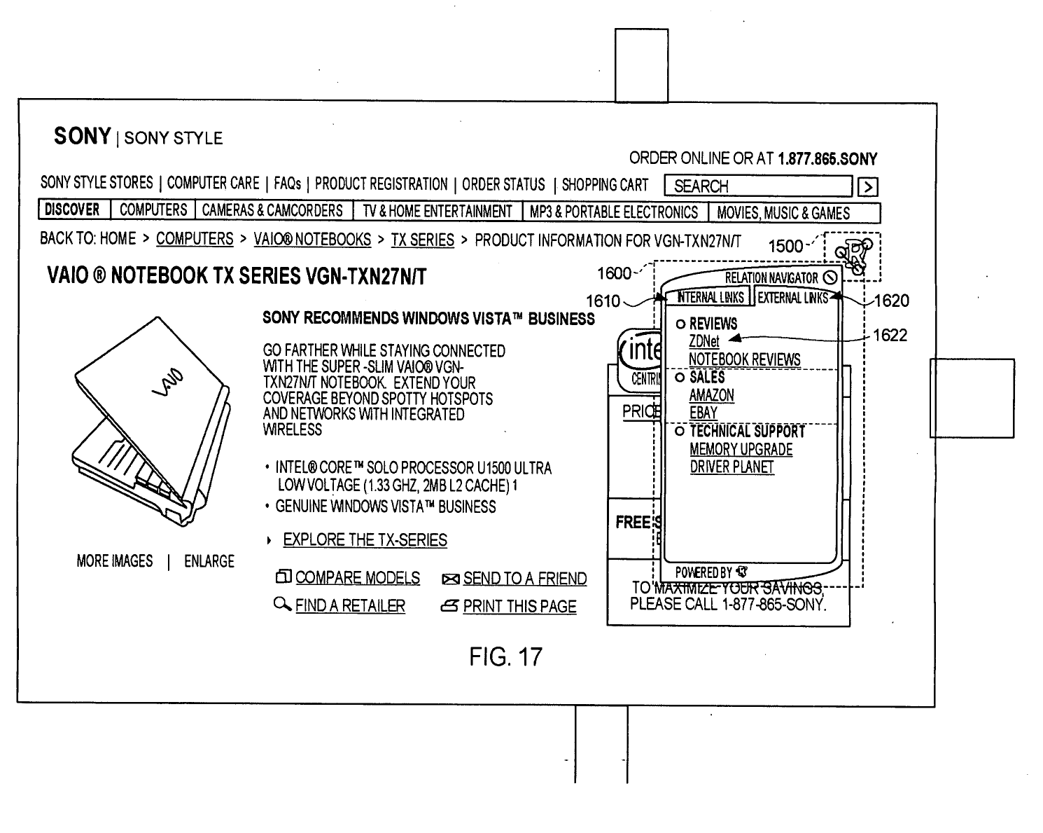

Referring now to FIG. 17, there is illustrated a screenshot of the same web page as in the FIG. 15. This time, the user has clicked on the top part of the “external links” panel 1620, making this panel the currently active one. Panel 1620 shows relational links to web pages that reside on domains other than the current domain. We can see that, again, the relational links are grouped into several categories, in this case being “Reviews”, “Sales”, and “Technical Support”. The first link in the “Reviews” section is numbered 1622.

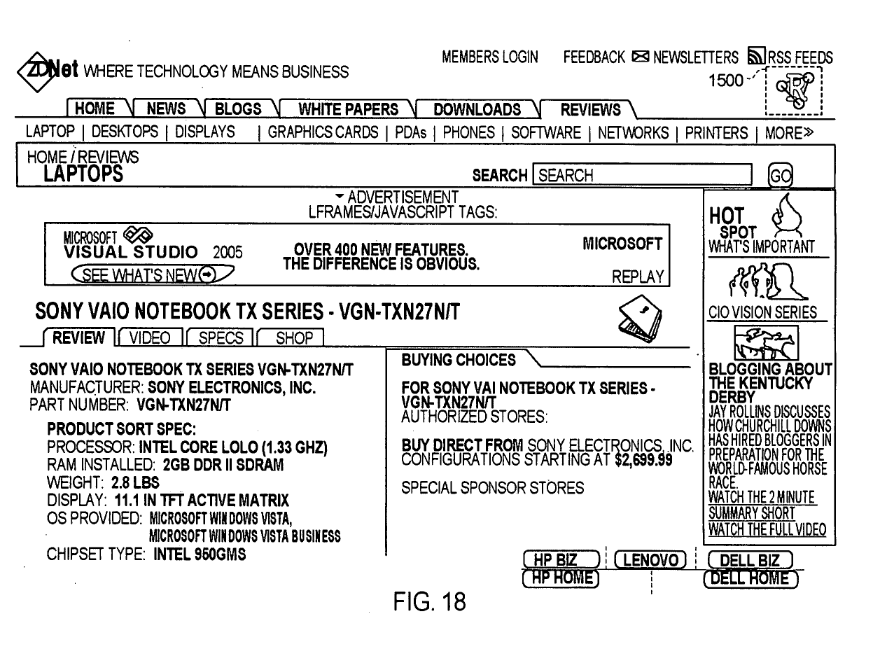

Referring now to FIG. 18, there is illustrated a screenshot of another web page, which opened up in the browser window after the user clicked link 1622 in the navigator window presented in FIG. 17. We can see that that page presents a review of the notebook model which was the subject of the previous web page.

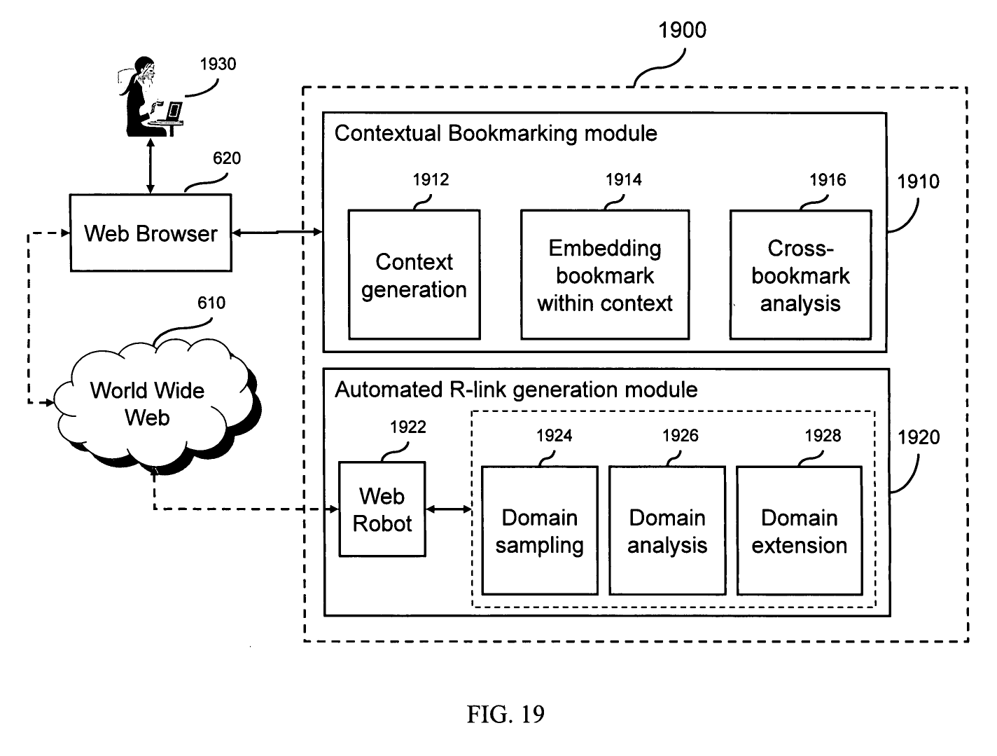

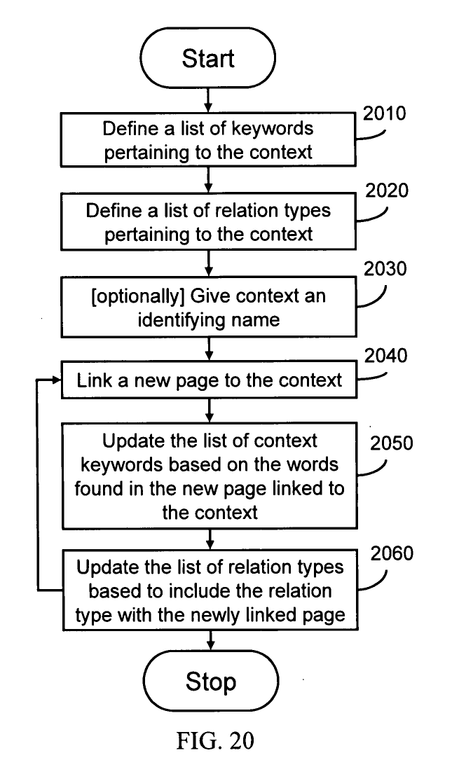

Referring now to FIG. 19, there is illustrated a block diagram of a system 1900 for generating relational links between pages on the web. This system 1900 comprises a module 1910 which allows human users to easily specify relational links between web pages through a method termed “contextual bookmarking”, and/or a means 1920 for automatically analyzing information on the web, finding relations between different web pages, and creating relational links corresponding to these relations. Turning our attention to the contextual bookmarking module 1910, this module communicates with a user 1930 through a web browser 620. The contextual bookmarking module 1910 implements three basic methods: a method 1912 for context generation, a method 1914 for embedding a bookmark within a given context, and a method 1916 for creating cross-links between existing contextual bookmarks. We shall now shortly describe the purpose and principle of each of these methods. More detailed description of these methods appears below, in reference to FIGS. 20-22.

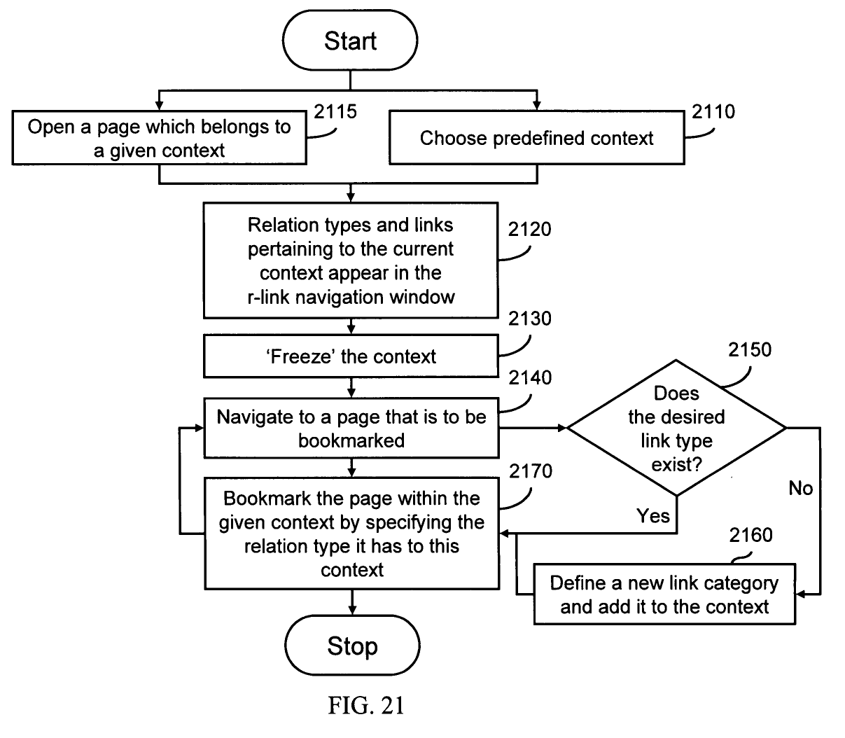

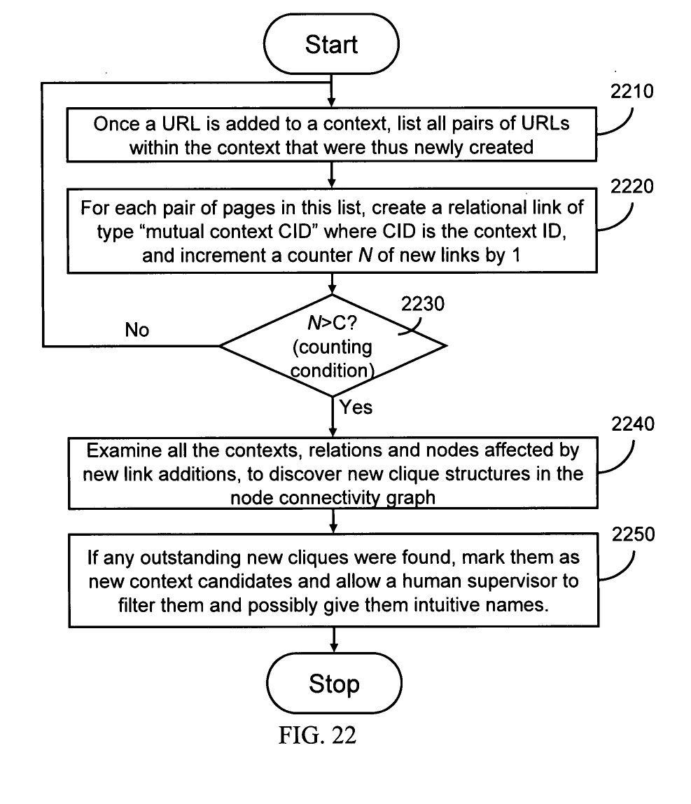

Contextual bookmarking is achieved when a page is related to a given subject (the ‘context’) through some relation definition. Different pages related to the same subject become relationally linked through r-links that express the common subject as well as how each page relates to that subject and to the other pages. The process of contextual bookmarking can be broken down into three distinct aspects: context definition entails some characterization of the subject matter and the relations that are relevant to this subject matter. This aspect is dealt with through method 1912, which is discussed below in reference to FIG. 20. Embedding of a bookmark within a given context requires a method through which the user can choose or specify the context and assign a page to this context, giving it a particular relation type to that context. This aspect is dealt with through method 1914, which is discussed below in reference to FIG. 21. Finally, when multiple pages are relationally linked to the same context, certain relations can be inferred between pairs of these pages, and stored as independent relational links. This aspect is dealt with through method 1916, which is discussed below in reference to FIG. 22.

Turning our attention now to the automated r-link generation module 1920, this module uses a “web robot” 1922 to gather information pertaining to a given knowledge domain from the World Wide Web, analyze that information in order to create a formal representation of the contexts within the domain, and then uses the web robot again to extend the scope of the contexts in this domain and add more r-links to them. To do so it uses three primary methods, to be described in more detail below: a domain sampling method 1924, a domain analysis method 1926, and a domain extension method 1928.

Referring now to FIG. 20, there is illustrated a flow chart of a process for defining a subject context, in conjunction with method 1912. At 2010, a list of keywords that characterize the context is defined each such keyword can be characterized by some a-priori “importance score”. At 2020, a list of relation types that can apply to the context is defined. At 2030, there is an option to give a name to the context. At 2040, a relational link between the context and a given page is defined. At 2050, the list of context keywords is updated according to the tokens found in the new page linked to the context: for each token that appears in the newly linked page, or in the existing list of context keywords, the term frequency (the number of appearances of the token in the new page) and the document frequency (the number of context-related documents in which this term has been observed) are computed. The importance score for the token is then updated in accordance with the difference between the new values of these two variables and their old values before the update. At 2060, the list of relation types applicable to the context is updated to include the relation type with the newly linked page, if that type was not in the list before. At this point a new page can be linked to the context, or the process can stop.

Referring now to FIG. 21, there is illustrated a flow chart of a process for bookmarking a page within a given context, in conjunction with method 1914. At 2110, a predefined context is chosen, e.g. through a menu operation or from a list or catalogue of predefined contexts. Alternatively, at 2115 a page belonging to one or more existing contexts is opened in the browser. In either case, the relevant contexts appear within a browser frame or window, or in a related but separate widget application (hereafter termed “the relational navigation window”), and if there is more than one relevant context the user is allowed to choose one specific context. At 2120, once a single context has been chosen, relation types and predefined links for the chosen context appear in the relational navigation window. At 2130 the user “freezes” the context through a menu operation or a mouse click on a freeze icon, which causes the context to remain fixed when opening other pages in the browser. At 2140, the user navigates to another page relevant to the frozen context. At 2150, if the desired link category for the new page already exists in the context, then at 2170 the user creates a contextual bookmark for that page by specifying the relation type between the context and that page. If the relation type already exists, this can be achieved by simply dragging the URL of the page from the address bar, and dropping it onto the relevant link category in the relational navigation window. Alternatively, there can be an icon next to each link category in the navigation window, pressing which links the currently viewed page to the currently active context through this relation category. To give a concrete example, assume that the context is a certain TV series, and that one of the predefined relations for this context is “fan clubs”. To link a new fan club to the context, the user “freezes” the context, navigates to the page for the new fan club, then drags the URL to the “Fan Clubs” link category or presses the “link” button next to this category name in the relational navigation window. If, at 2150, the desired link category does not yet exist for the chosen context, then at 2160 the user defines the new link category and adds it to the context, then proceeding to adding the link under this category at 2170. Stages 2140 to 2170 can be repeated multiple times to link multiple new pages to the context.

Referring now to FIG. 22, there is illustrated a flow chart of a process for cross-bookmark analysis, in conjunction with method 1916. At 2210, whenever a new URL is added to a context, all pairs of URLs within the context that were newly created by this addition are listed. At 2220, a relational link is created for each such new URL pair, with the relation ID corresponding to the ID of the mutual context. Additionally, a counter of new links (initially set to 0) is incremented by 1. At 2230, it is checked whether a critical number of new links has been created. If not, steps 2210 and 2220 are repeated. If yes, all the contexts, relations and nodes that were affected by the recent URL additions are re-examined and analyzed for the appearance of new cliques within the node connectivity graph. At 2250, any outstanding new cliques that were so identified are marked as new context candidates and presented to a human supervisor who can filter them and/or give them intuitively meaningful titles.

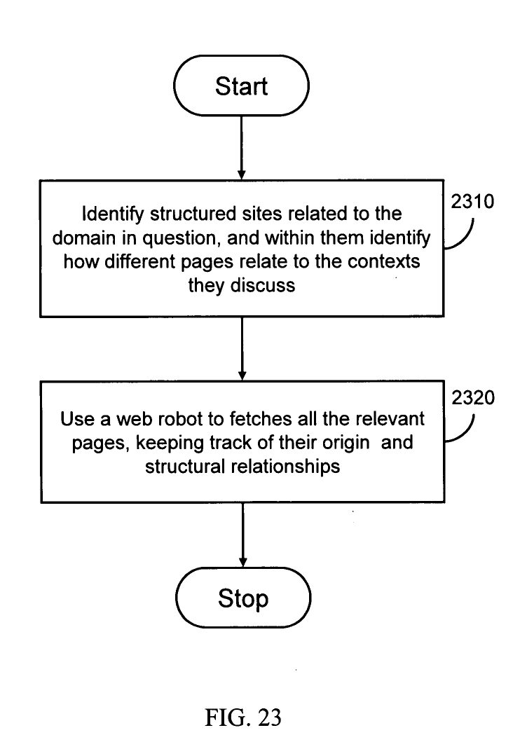

Referring now to FIG. 23, there is illustrated a flow chart of a process for domain sampling, in conjunction with method 1924. At 2310, the operator identifies some well-structured websites which provide good coverage for the knowledge domain to be mapped. Some of these sites may cover only certain aspects, and others may cover other aspects. Within each site, the operator takes advantage of the site structure to identify and specify how different pages relate to the context they refer to. At 2320, a web robot fetches all the relevant pages from the chosen sites, keeping track of their structural relationships and how they match pre-identified relations.

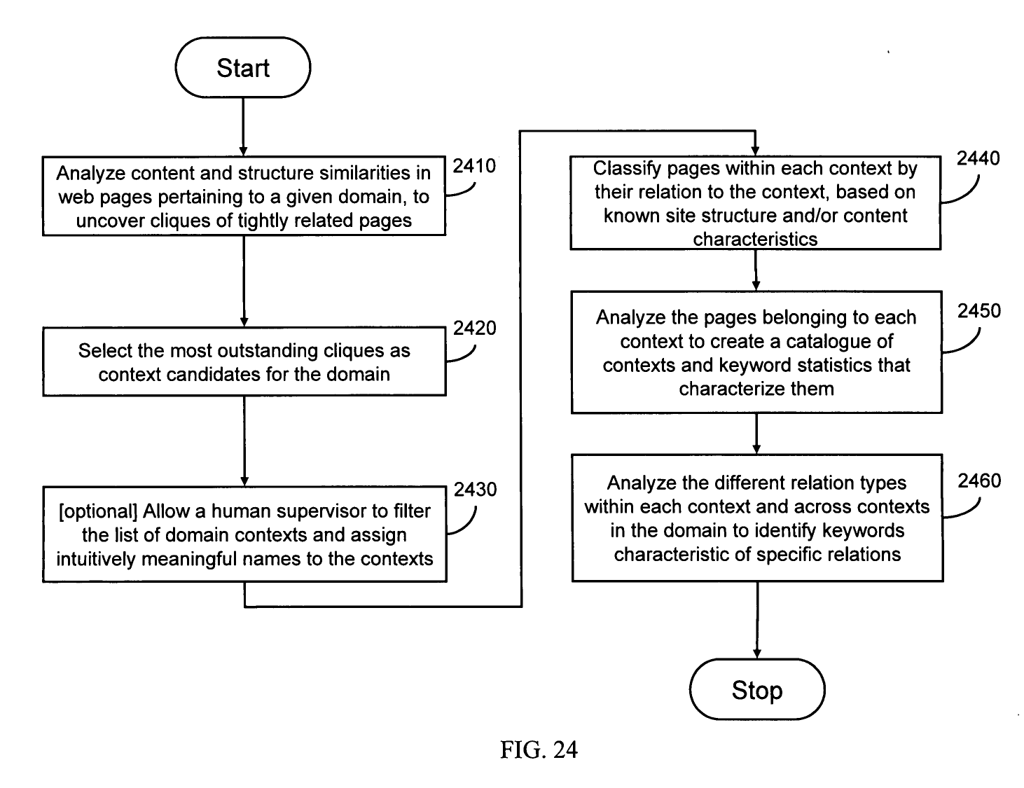

Referring now to FIG. 24, there is illustrated a flow chart of a process for domain analysis, in conjunction with method 1926. At 2410, content and structure similarities between pages related to the knowledge domain are analyzed, and cliques of pages which have tightly linked content are identified. At 2420, the most outstanding of these cliques are characterized by keywords which distinguish them, and marked as candidate contexts for the domain. At 2430, a human supervisor can optionally filter the list of candidate contexts, possibly choosing some of the candidates, and assigning meaningful and intuitive names to correctly identified contexts. For example, in an analysis of a foreign affairs news domain, a clique may surface which is characterized by frequent appearance of the words ‘Iran’, and ‘nuclear’. After examining pages belonging to this clique, the supervisor may elect to label it “Iran's nuclear plans”. At 2440, pages within each chosen context are classified by their relation to the context, using know properties of the site structure, pre-defined lists of characteristic keywords for the various relations, emergent statistical properties of sub-clusters of pages within the context, or a combination of the above methods. At 2450, a catalogue of contexts is created, whereby each context is characterized by a set of keywords whose frequency (individually or in combination with each other) is significantly higher for this context than in general. At 2460, a similar analysis is performed at the level of the different relations within each context.

It should be noted that the methods 1924 and 1926 for domain sampling and domain analysis are not limited to the details of the specific implementation described in FIGS. 23 and 24. For example, in certain cases highly organized information pertaining to different contexts and different relations within each context may exist in the form of encyclopedic entries, data in a relational database, or formalized semantic description using standards such as the Resource Description Framework (RDF) and Web Ontology Language (OWL). In such cases the process of sampling and analyzing a knowledge domain to obtain the characterization of contexts and relations may be much simplified.

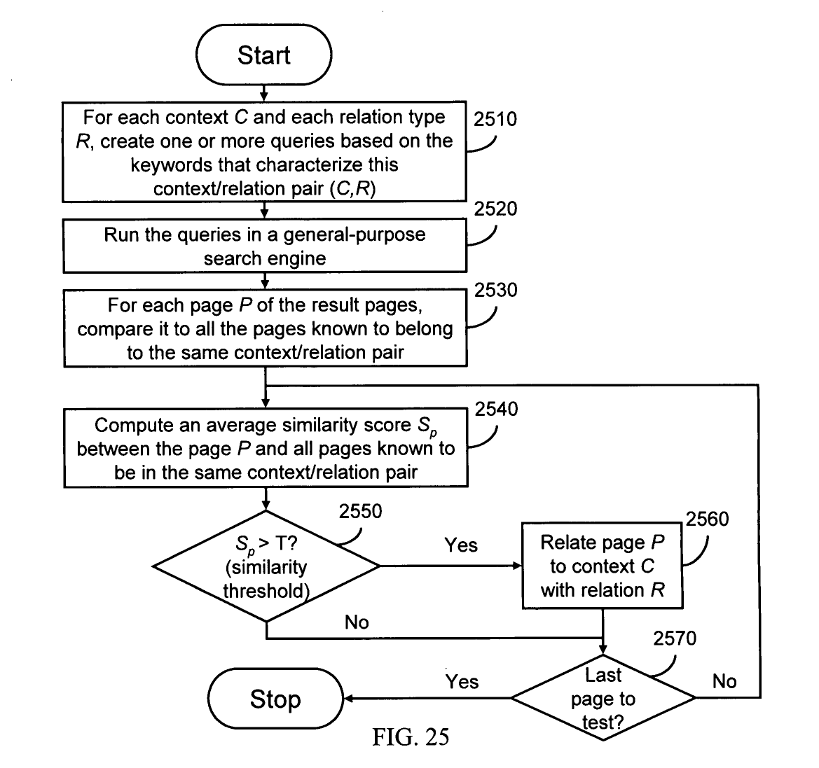

Referring now to FIG. 25, there is illustrated a flow chart of a process for domain extension, in conjunction with method 1928. At 2510, each pair (C,R) of context and relation in the domain is associated with one or more sets of keywords that are highly characteristic of this pair, in that their individual or mutual occurrence within pages corresponding to this context and pair is much higher than can be expected in general texts. At 2520, the set or sets of keywords corresponding to each context-relation pair are submitted as queries to a general purpose web search engine, and the results are recorded. At 2530, each page P within the result pages for a context-relation pair (C,R) is compared with all the documents that are already known to belong to this context-relation pair, and a similarity score is computed between page P and each of these pre-known documents. At 2540, an average similarity score Sₚ is computed for page P with respect to the context-relation pair (C,R). At 2550, the similarity score Sₚ is compared with a predefined threshold T. If the score passes this threshold, page P is marked as corresponding to the context-relation pair (C,R), otherwise it is discarded. The process continues until a sufficient number of pages have been added to the context-relation pair (C,R).

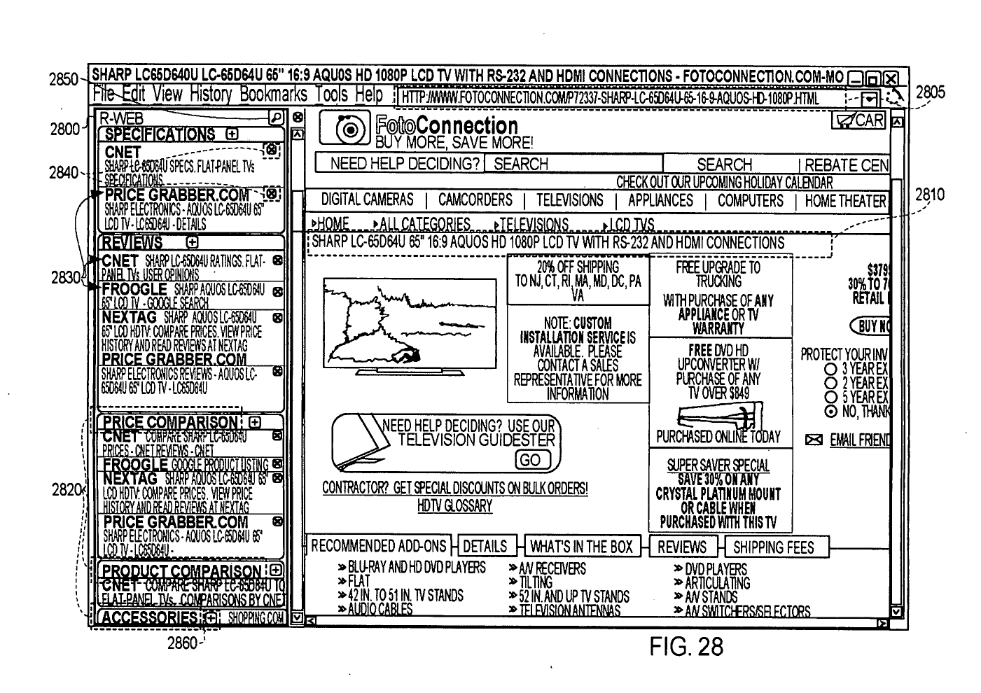

Referring now to FIG. 28, there is illustrated a screenshot of a browser with a relational-navigation plug-in developed by R-Web Inc., which embodies several of the systems and methods described above. The left area of the browser window is occupied by the plug-in bar 2800, whereas the area to its right displays the page whose URL 2805 can be seen in the navigation bar at the top of the window. The viewed page in this screenshot deals with a certain high definition television model, as can be seen in 2810. The R-Web plug-in transmits information about the viewed URL to the R-Web servers, where analysis of the URL content is performed and this page is compared with URLs and context already stored in the R-Web database. In this case, although the viewed page itself was never indexed before in the R-Web database, high similarity to a single context was identified, this context corresponding to the television model discussed in the open URL. As a result, the plug-in bar 2800 shows the multiple relations that are associated with this context (some of which are indicated by 2820)—namely, specifications, reviews, price comparisons, product comparisons, etc. For each of these relation categories, one or more links are presented (some of which are indicated by 2830). Next to each link, there is a small “x” icon (2840). Pressing this icon lets the user indicate to the plug-in that he finds this particular link misleading or simply not very useful. As a result, a deletion request counter is incremented for this particular URL in the R-Web database. Additionally, it is marked as “not to display” for this particular user. This r-link would still be shown to other users, who have not asked to delete it, unless its deletion request counter exceeds a certain threshold, at which point it stops being presented to all plug-in users. At the top of the plug-in bar, there is a “freeze” icon 2850. Pressing this icon causes the plug-in bar to stay fixed, instead of the usual behavior whereby it refreshed whenever the URL at 2805 is changed. When the freeze icon is pressed (indicated by a different color and shape), the user can navigate to a new page, and create an r-link between it and any of the existing relations for the frozen context, by pressing the green “+” icon (2860 and its like) next to the appropriate relation category title.

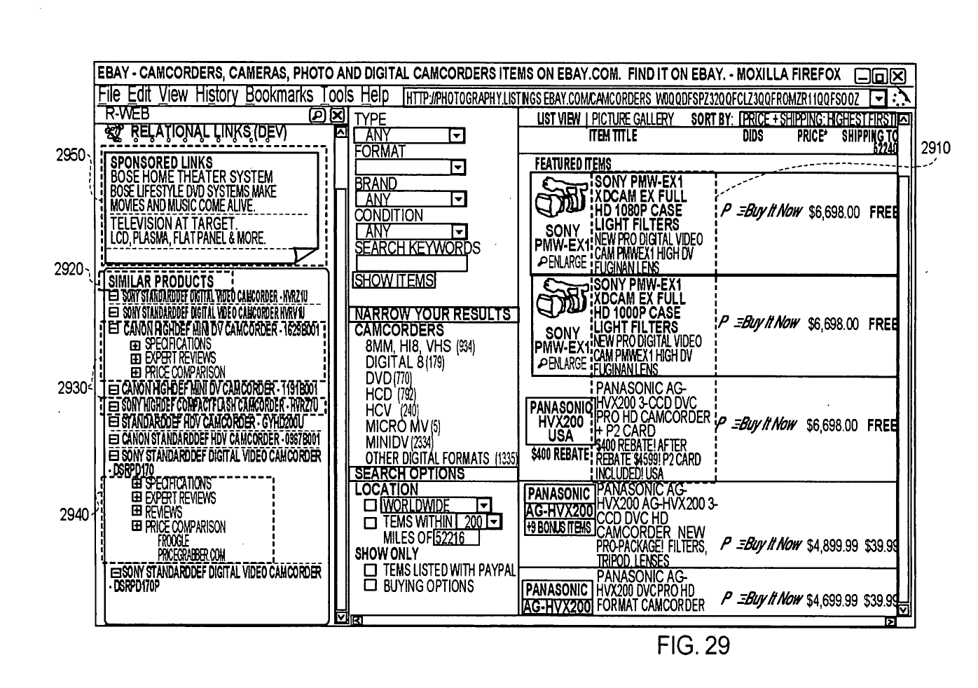

Referring now to FIG. 29, there is illustrated another screenshot of a browser with the same navigation plug-in depicted in FIG. 28. This time, the page opened in the browser features multiple models of high-definition camcorders, as can be seen in 2910. In this case, no single context could be identified as most appropriate for the observed page. Instead, multiple different contexts were identified, corresponding to several different models of high-definition camcorders. The plug-in bar therefore displays the title “similar products (2920), under which the different contexts appear (some of which are indicated by 2930). Pressing on the title of a given context (a given camcorder model in this case) causes a sub-menu to open (see 2940), displaying the different relation categories for this context. Pressing one of these relation categories (see 2940 again) displays the r-links within this relation, which can be clicked to navigate directly to the pages they point to. Finally, it should be noted that the plug-in bar can also display sponsored links 2950. The choice of which sponsored links or advertisements to display is governed by the exact same methods that govern the display of highly relevant r-links, thus ensuring very high-quality targeting of sponsored links and ads to the specific contexts the user is interested in.

While the foregoing has been with reference to a particular embodiment of the invention, it will be appreciated by those skilled in the art that changes in this embodiment may be made without departing from the principles and spirit of the invention, the scope of which is defined by the appended claims.

1. A system for storing, accessing, and presenting information about relational links between content elements in a centralized or distributed information system, such relations being uni-directional or bi-directional and having one or more relation-type properties, the system comprising:
an information system;
an information display module for displaying information stored in the information system;
a storage module for storing information about a relation between a plurality of nodes wherein each node is a different content element;
an access module for accessing, given a particular node, all of the other nodes having stored relations with that particular node and generating a list of inter-related nodes; and
a link display module for presenting the list of inter-related nodes and the relations between those inter-related nodes.

2. The system of claim 1, wherein the storage module stores each relation between two nodes as a record within an relational database management system.

3. The system of claim 2, wherein the storage module stores a set of attributes corresponding to each node and a set of relations between one or more of the attributes.

4. The system of claim 3, wherein the access module calculates relations between any two given nodes based on the stored attributes for each of the two nodes, and the stored relations between these attributes.

5. The system of claim 4 wherein the information system is the World Wide Web and content elements are pages in a markup language or other types of media embedded or hyperlinked to from within such pages.

6. A system for creating websites with links between different content elements of the site based on the relations between these content elements, comprising:
a content editor for editing and formatting content in a way suitable for presentation on a display medium;
a relation type definition module for defining or modifying different types of relations between content elements, each relation being either directed (asymmetrical) or undirected (symmetrical), and carrying additional relation type information;
a storage module for storing content elements and relations between content elements; and
a content relations editor for relating content elements to information nodes, and defining relations between different information nodes.

7. The system of claim 6, further comprising:
a retrieval module for retrieving all content elements from an existing website and listing them in a structured manner
an analysis module for analyzing hyperlinks between content elements in the existing website, and suggesting appropriate types of relational links to replace them

8. A system for navigating content stored in a centralized or distributed information system, comprising:
a display module for displaying content stored in the information system and for accessing a specific content element by specifying a Uniform Resource Identifier (URI) corresponding to that element
a content mapping module for generating, storing, and accessing links between content elements based on relationships between such elements
a navigation module for displaying links to one or more content elements, wherein the links are obtained from the content mapping module based on their relations to the content currently being displayed in the display module, and other attributes provided by the navigation module.

9. The system of claim 8, wherein the content mapping module is on a remote server or multiple servers, connected remotely with the navigation module.

10. The system of claim 8, wherein the information system is the World Wide Web.

11. The system of claim 8, wherein the attributes provided by the navigation module to the content mapping module include information about a navigation history.

12. The system of claim 8, wherein the attributes provided by the navigation module to the content mapping module include a reference to user preferences that can be set by the user of the system, or modified automatically as a result of communication between the navigation module and the content mapping module.

13. The system of claim 8, wherein the content mapping module further comprises a collaborative filtering element.

14. The system of claim 8, wherein the display module is a web browser

15. The system of claim 8, wherein the display module is a mobile web browser, and the information system is either the World Wide Web or the Mobile Web.

16. A system for contextual bookmarking, comprising:
a contextual bookmarking module that permits a user to specify a relational link between one or more web pages; and
the contextual bookmarking module further comprising a context generation unit that allows the user to generate a new context for a web page, a bookmark unit that allows the user to bookmark a web page within a context using a contextual bookmark, and a cross-link unit that creates cross-links between existing contextual bookmarks.

17. A system for automatic contextual bookmarking, comprising:
a robot for gathering information about a knowledge domain for an information system;
an automated relational link generation module that analyzes the information about a knowledge domain to create a formal representation of one or more contexts within the domain; and
the automated relational link generation module further comprising a domain sampling unit that generates a sample of a domain, a domain analysis unit that analyzes the sample of the domain to determine a context and a relation of the domain and a domain extension unit that extends the domain by associating the context and the relation of the domain with one or more set of keywords.

18. The system of claim 17, wherein the information system further comprises a computer network.

19. The system of claim 16, wherein the bookmark unit further comprises a context recognition module that identifies and displays the most relevant known contexts corresponding to a given viewed page, a means to freeze a chosen context so that it does not change when viewing different pages, a means to add a new relation type to a frozen context and a means to bookmark a viewed page under each relation type within a frozen context.
